(19) United States
(12) Patent Application Publication
(10) Pub. No.: US 2023/0371597 A1
(43) Pub. Date: Nov. 23, 2023

(54) AEROSOL GENERATION DEVICE AND INFRARED HEATER

(71) Applicant: SHENZHEN FIRST UNION TECHNOLOGY CO., LTD., Shenzhen City, Guangdong Province (CN)

(72) Inventors: SHEN QI, Shenzhen City, Guangdong Province (CN); BAOLING LEI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/028,211

(22) PCT Filed: Sep. 23, 2021
(86) PCT No.: PCT/CN2021/119924

§ 371 Date: Mar. 23, 2023

(30) Foreign Application Priority Data
Sep. 23, 2020 (CN) 202011005746.3

(51) Int. Cl. A24F 40/46; A24F 40/20; H05B 3/44

(52) U.S. Cl. CPC A24F 40/46; A24F 40/20; H05B 3/44

(57) ABSTRACT

This application provides an aerosol generation device and an infrared heater. The aerosol generation device includes a chamber configured to receive an aerosol forming substrate, at least one infrared heater, and a battery cell providing power to the infrared heater, where the infrared heater includes: a complex, prepared by a composite material containing a carbon material and a ceramic material; and the complex is constructed to heat the aerosol forming substrate received in the chamber at least in an infrared radiation manner; and a conductive element, including a first electrode and a second electrode spaced apart on the complex; and the conductive element is configured to provide the power to the complex. The complex composed of the carbon material and the ceramic material radiates infrared to heat the aerosol forming substrate received in the chamber, so that the infrared heater is simple in preparation and suitable for mass production.

### CROSS-REFERENCE TO RELATED APPLICATIONS

This application claims priority to Chinese Patent Application No. 202011005746.3, filed with the China National Intellectual Property Administration on Sep. 23, 2020 and entitled “AEROSOL GENERATION DEVICE AND INFRARED HEATER”, which is incorporated herein by reference in its entirety.

### TECHNICAL FIELD

Embodiments of this application relate to the field of cigarette device technologies, and in particular, to an aerosol generation device and an infrared heater.

### BACKGROUND

During use of smoking objects such as a cigarette or cigar, tobaccos are burnt to generate vapor. A product that releases compounds without burning has been tried to provide an alternative for the objects that burn tobaccos. An example of the products is a heat-not-burn product, which releases compounds by heating tobaccos rather than burning tobaccos.

In an existing low-temperature heat-not-burn cigarette device, a base body is mainly coated with a far-infrared electric heating coating and a conductive coating, and the electrified far-infrared electric heating coating emits far-infrared to penetrate the base body to heat an aerosol forming substrate in the base body. Because the far-infrared has relatively strong penetrability, and may penetrate the periphery of the aerosol forming substrate to enter the aerosol forming substrate, the aerosol forming substrate is heated relatively evenly.

However, the cigarette device has problems of a complex manufacturing process and relatively high costs.

### SUMMARY

This application provides an aerosol generation device and an infrared heater, aiming to resolve problems of a complex manufacturing process and relatively high costs in an existing cigarette device.

An aspect of this application provides an aerosol generation device, including a chamber configured to receive an aerosol forming substrate, at least one infrared heater, and a battery cell providing power to the infrared heater, where
the infrared heater includes:
a complex, prepared by a composite material containing a carbon material and a ceramic material; and the complex is constructed to heat the aerosol forming substrate received in the chamber at least in an infrared radiation manner; and
a conductive element, including a first electrode and a second electrode spaced apart on the complex; and the conductive element is configured to provide the power to the complex.

Another aspect of this application provides an infrared heater for an aerosol generation device, the aerosol generation device including a chamber configured to receive an aerosol forming substrate and a battery cell providing power to the infrared heater, where the infrared heater includes:
a complex, prepared by a composite material containing a carbon material and a ceramic material; and the complex is constructed to heat the aerosol forming substrate received in the chamber at least in an infrared radiation manner; and
a conductive element, including a first electrode and a second electrode spaced apart on the complex; and the conductive element is configured to provide the power to the complex.

In the aerosol generation device and the infrared heater provided in this application, the complex composed of the carbon material and the ceramic material radiates infrared to heat the aerosol forming substrate received in the chamber, so that the infrared heater is simple in preparation and suitable for mass production.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic diagram of an aerosol generation device according to an implementation of this application;

FIG. 2 is a schematic diagram of an aerosol generation device with a cigarette inserted according to an implementation of this application;

FIG. 3 is a schematic diagram of an infrared heater according to an implementation of this application;

FIG. 4 is a schematic planar diagram of an infrared heater unfolded according to an implementation of this application;

FIG. 5 is a schematic diagram of another infrared heater according to an implementation of this application;

FIG. 6 is a schematic planar diagram of another infrared heater unfolded according to an implementation of this application;

FIG. 7 is a schematic diagram of still another infrared heater according to an implementation of this application; and

FIG. 8 is a schematic diagram of another aerosol generation device according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in art of this application. Terms used in this specification of this application are merely intended to describe objectives of the specific implementations, and are not intended to limit this application. The term “and/or” used in this specification includes any or all combinations of one or more related listed items.

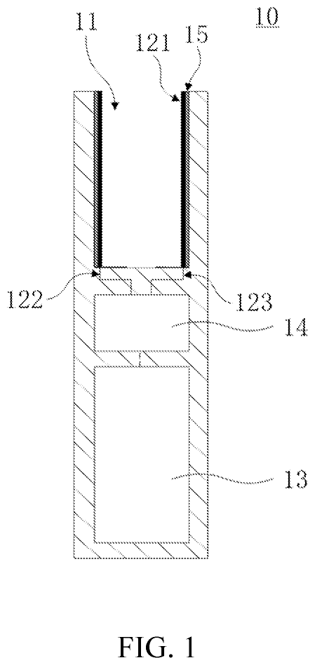

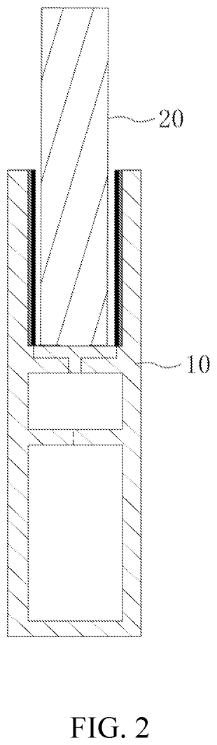

FIG. 1 and FIG. 2 show an aerosol generation device 10 provided in an implementation of this application and including the following:

A chamber 11 is configured to receive an aerosol forming substrate, for example, a cigarette 20.

The aerosol-forming substrate is a substrate that can release a volatile compound that can form an aerosol. The volatile compound can be released by heating the aerosol-forming substrate. The aerosol-forming substrate may be solid, or liquid, or components including solid and liquid. The aerosol-forming substrate may be loaded onto a carrier or support through adsorbing, coating, impregnating, or in other manners. The aerosol-forming substrate may conveniently be a part of the aerosol-forming article.

The aerosol-forming substrate may include nicotine. The aerosol-forming substrate may include tobacco, for example, a tobacco-containing material including a volatile tobacco aroma compound. The volatile tobacco aroma compound is released from the aerosol-forming substrate when heated. Preferably, the aerosol-forming substrate may include a homogeneous tobacco material. The aerosol-forming substrate may include at least one aerosol-forming agent, and the aerosol-forming agent may be any suitable known compound or a mixture of compounds. During use, the compound or the mixture of compounds facilitates condensing and stabilizing formation of the aerosol and is substantially resistant to thermal degradation at an operating temperature of an aerosol-forming system. Suitable aerosol-forming agents are well known in the related art and include, but are not limited to: polyol, such as triethylene glycol, 1, 3-butanediol, and glycerol; ester of polyol, such as glycerol mono-, di- or triacetate; and fatty acid ester of mono-, di- or polycarboxylic acid, such as dimethyl dodecanedioate and dimethyl tetradecanedioate. Preferably, the aerosol forming agent is polyhydric ester or a mixture thereof, such as triethylene glycol, 1,3-butanediol, or most preferably, glycerol.

An infrared heater is constructed to radiate infrared to the chamber 11, to heat the aerosol forming substrate received in the chamber 11.

A battery cell 13 provides power used for operating the aerosol generation device 10. For example, the battery cell 13 may provide power to heat the infrared heater. Moreover, the battery cell 13 may provide power required for operating other elements provided in the aerosol generation device 10.

The battery cell 13 may be a rechargeable battery or a disposable battery. The battery cell 13 may be, but is not limited to, a lithium iron phosphate (LiFePO4) battery. For example, the battery cell 13 may be a lithium cobaltate (LiCoO2) battery or a lithium titanate battery.

A circuit 14 may control an overall operation of the aerosol generation device 10. The circuit 14 not only controls operations of the battery cell 13 and the infrared heater, but also controls operations of other elements in the aerosol generation device 10. For example, the circuit 14 obtains information about a temperature of the infrared heater sensed by a temperature sensor, and controls, according to the information, power provided by the battery cell 13 to the infrared heater.

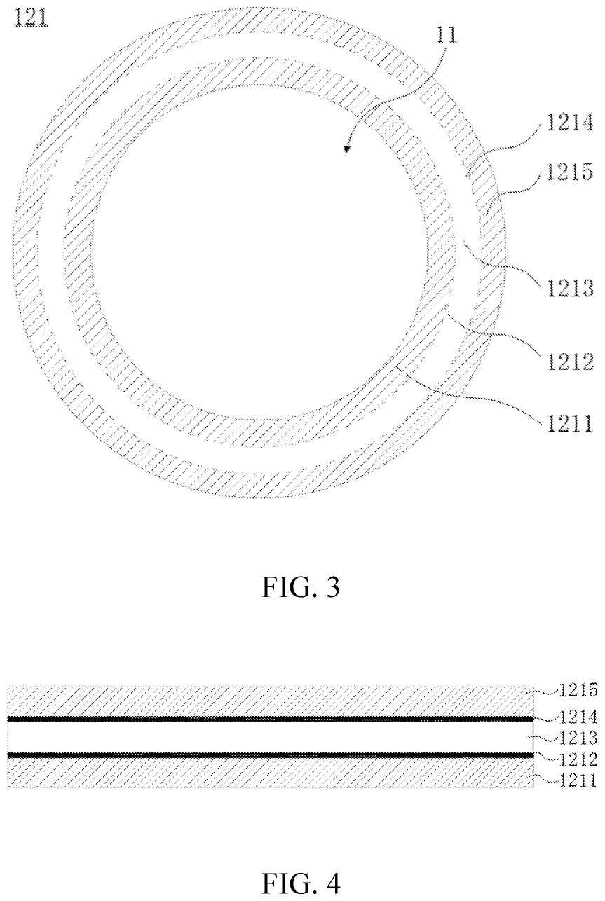

FIG. 3 and FIG. 4 show an infrared heater according to an implementation of this application. The infrared heater includes a complex 121 and a conductive element.

In this example, the complex 121 is constructed as a tube shape extending in an axial direction of a chamber 11 and surrounding the chamber 11. An inner surface of the complex 121 faces the chamber 11, or forms at least one part of the chamber 11. It should be noted that, in another example, the complex 121 may alternatively not be in a tube shape, but be, for example, a prism shape, a plate shape, or a half-cylinder shape.

The complex 121 is prepared by a composite material containing a carbon material and a ceramic material. The carbon material may be made of a derivative and a compound having carbon as some or all component elements and including, but not limited to, at least one of carbon nanotube, graphite, graphene, and carbon fiber. The ceramic material includes but is not limited to at least one of aluminum oxide, zirconium oxide, and yttrium oxide.

Specifically, the complex 121 is an integral structure formed by a ceramic material layer 1211, a ceramic material layer 1215, and a carbon material layer 1213 arranged between the ceramic material layer 1211 and the ceramic material layer 1215 through high-temperature sintering. After the high-temperature sintering, the ceramic material layer 1211 is formed on the inner surface of the complex 121 with the tubular structure, and the ceramic material layer 1215 is formed on an outer surface of the complex 121 with the tubular structure. Because the carbon material layer 1213 is arranged between the ceramic material layer 1211 and the ceramic material layer 1215 and is not in contact with the air, the problem that it is easy for an oxidization reaction to occur in the carbon material may be avoided.

Further, an organic carrier layer 1212 (shown by a dashed line in FIG. 3) is arranged between the ceramic material layer 1211 and the carbon material layer 1213, and an organic carrier layer 1214 is arranged between the ceramic material layer 1215 and the carbon material layer 1213, so that the carbon material layer and the ceramic material layers may be better composed through the organic carrier layers. The organic carrier layers include but are not limited to glass powder and acrylic latex.

An implementation process of the complex 121 is described below with a carbon fiber material and a zirconium oxide material as an example:

Step 11: Select a carbon fiber material for a carbon fiber film, where a carbon fiber diameter is 50 to 200 nanometers; and use zirconium oxide for a ceramic base body.

Step 12: Polish a surface of the ceramic base body, then spray an organic carrier layer on the surface, stand for 2 to 5 hours, and then cover the organic carrier layer with a surface of the carbon fiber film. Similarly, the organic carrier layer and the ceramic base body are sequentially formed on another surface of the carbon fiber film.

Step 13: Place a sample obtained in step 12 into a reducing atmosphere furnace, warm up to about 1200 degrees, sinter for about 2 hours, and then obtain a carbon fiber/ceramic composite material as the furnace cools down.

The composite material has conductivity, and can radiate, after conducting electricity, infrared to the chamber 11, to heat the aerosol forming substrate received in the chamber 11.

Referring to FIG. 1 again, a conductive element includes a first electrode 122 and a second electrode 123 spaced apart on a complex 121; and the conductive element is configured to provide power of the battery cell 13 to the complex 121. The first electrode 122 and the second electrode 123 may be directly printed or deposited on the complex 121, and may be made of materials of metal or alloy with a low resistivity, such as silver, gold, palladium, platinum, copper, nickel, molybdenum, tungsten, niobium, or an alloy material of the foregoing metals.

Further, the infrared heater may further include a heat insulation tube 15, and the heat insulation tube 15 is arranged on a periphery of the complex 121. The heat insulation tube 15 may avoid a case that a large quantity of heat is transferred onto a shell of the aerosol generation device 10 to make a user feel hot. An infrared reflection layer may be further formed on an inner surface of the heat insulation tube 15, and the infrared reflection layer may reflect the infrared radiated by the infrared heater to the chamber 11, to improve infrared heating efficiency. The infrared emitting layer may be made of one or more of gold, silver, nickel, aluminum, gold alloy, silver alloy, nickel alloy, aluminum alloy, gold oxide, silver oxide, nickel oxide, aluminum oxide, titanium oxide, zinc oxide, and cerium dioxide.

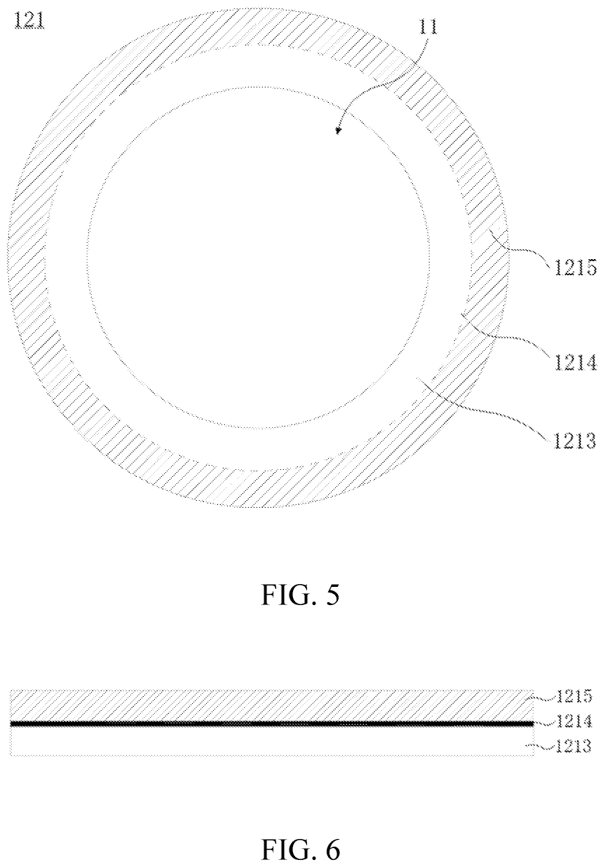

FIG. 5 and FIG. 6 show another infrared heater according to an implementation of this application. Different from FIG. 3 and FIG. 4, a complex 121 is an integral structure formed by a ceramic material layer 1215, a carbon material layer 1213, and an organic carrier layer 1214 arranged between the ceramic material layer 1215 and the carbon material layer 1213 through high-temperature sintering; and the ceramic material layer 1215 is formed on an outer surface of the complex 121, and the carbon material layer 1213 faces a chamber 11.

It should be noted that, in another example, it is also possible that the ceramic material layer 1215 is formed on an inner surface of the complex 121 and the carbon material layer 1213 faces away from the chamber 11. After being coupled to the battery cell 13 through a conductive element, the carbon material layer 1213 radiates infrared, and the infrared penetrates the ceramic material layer 1215, to heat the aerosol forming substrate received in the chamber 11.

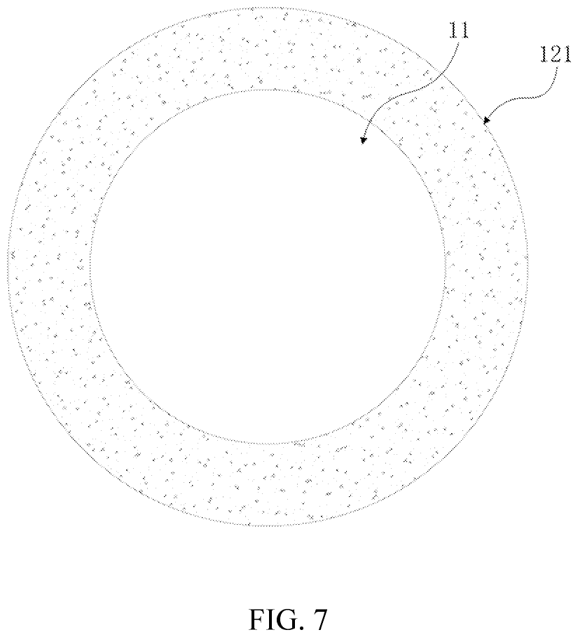

FIG. 7 shows still another infrared heater according to an implementation of this application. Different from FIG. 3 and FIG. 4, a complex 121 is an integral structure formed by carbon material powder and ceramic material powder through high-temperature sintering. The content of the carbon material powder affects each of conductivity, resistance magnitude, and infrared emissivity of the complex 121 to a specific extent. In the example, a mass fraction of the carbon material powder is 5% to 20%, and preferably 5% to 15%. Because the carbon material becomes a component of the complex 121, the problem that it is easy for an oxidization reaction to occur in the carbon material may also be avoided.

An implementation process of the complex 121 is described below still with a carbon fiber material and a zirconium oxide material as an example:

Step 21: Perform wet ball milling on a zirconium oxide material and a carbon fiber material for 6 to 10 h, where a mass fraction of the carbon fiber material is 10%.

Step 22: Dry a material obtained in step 21, then put the dried material into a graphite mold, and place the graphite mold in an SPS (Spark Plasma Sintering) furnace.

Step 23: Vacuumize the SPS furnace, and start sintering after a vacuum degree reaches 4 Pa, where a temperature rise control rate is 50 to 100° C./min, and a sintering pressure is 50 MPa.

Step 24: Hold for 3 min at a highest sintering temperature, and then turn off the SPS furnace; and then obtain a carbon fiber/ceramic composite material as the furnace cools down.

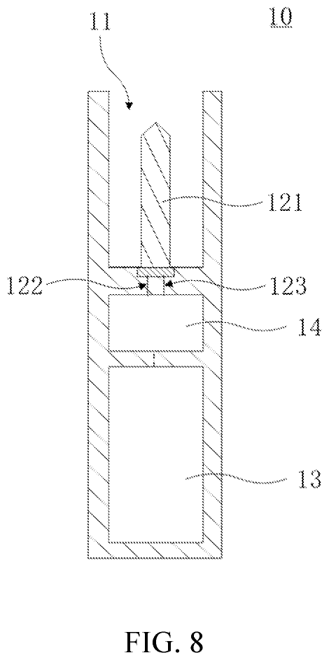

FIG. 8 shows another aerosol generation device 10 according to an implementation of this application. Different from FIG. 1 to FIG. 7, the complex 121 is constructed to be insertable into the aerosol forming substrate received in the chamber 11. For the structure of the complex 121, reference may be made to FIG. 3 to FIG. 7. Preferably, the complex 121 is an integral structure formed by a carbon material layer and a ceramic material layer through high-temperature sintering, where the carbon material layer is arranged inside the complex 121, and the ceramic material layer wraps the carbon material layer; or the complex 121 is an integral structure formed by carbon material powder and ceramic material powder through high-temperature sintering. The complex 121 may be constructed in a needle shape or sheet shape, an end portion of which has a protrusion, so that the complex may be inserted into the aerosol forming substrate.

It should be noted that, the foregoing embodiment is described with only one infrared heater as an example. In another example, the aerosol generation device 10 may include a first infrared heater and a second infrared heater, and the first infrared heater and the second infrared heater are constructed to independently start to implement segmented heating.

For structures of the first infrared heater and the second infrared heater, reference may be made to the foregoing content. Details are not described herein. The first infrared heater and the second infrared heater may be arranged in an axial direction of a chamber 11, to heat different parts in an axial direction of an aerosol forming substrate, and then implement segmented heating; and may alternatively be arranged in a circumferential direction of the chamber 11, to heat different parts in the circumferential direction of the aerosol forming substrate, and then implement segmented heating.

It should be noted that, this specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or variations according to the above descriptions, and such improvements and variations shall all fall within the protection scope of the appended claims of this application.

1. An aerosol generation device, comprising a chamber configured to receive an aerosol forming substrate, at least one infrared heater, and a battery cell providing power to the infrared heater, wherein:
the infrared heater comprises:
a complex, prepared by a composite material containing a carbon material and a ceramic material; and the complex is constructed to heat the aerosol forming substrate received in the chamber at least in an infrared radiation manner; and
a conductive element, comprising a first electrode and a second electrode spaced apart on the complex; and the conductive element is configured to provide the power to the complex.

2. The aerosol generation device according to claim 1, wherein the complex is an integral structure formed by a carbon material layer and a ceramic material layer through high-temperature sintering.

3. The aerosol generation device according to claim 2, wherein the ceramic material layer forms at least a part of a surface of the complex.

4. The aerosol generation device according to claim 3, wherein the complex is an integral structure formed by a first ceramic material layer, a second ceramic material layer, and a carbon material layer arranged between the first ceramic material layer and the second ceramic material layer through high-temperature sintering.

5. The aerosol generation device according to claim 2, wherein an organic carrier layer is arranged between the carbon material layer and the ceramic material layer.

6. The aerosol generation device according to claim 5, wherein the organic carrier layer comprises at least one of glass powder and acrylic latex.

7. The aerosol generation device according to claim 1, wherein the complex is an integral structure formed by carbon material powder and ceramic material powder through high-temperature sintering.

8. The aerosol generation device according to claim 7, wherein a mass fraction of the carbon material powder is 5% to 20%, and preferably 5% to 15%.

9. The aerosol generation device according to claim 1, wherein the complex is constructed as a tube shape extending in an axial direction of the chamber and surrounding the chamber.

10. The aerosol generation device according to claim 1, wherein the complex is constructed to be insertable into the aerosol forming substrate received in the chamber.

11. The aerosol generation device according to claim 1, wherein the aerosol generation device comprises a first infrared heater and a second infrared heater, and the first infrared heater and the second infrared heater are constructed to independently start to implement segmented heating.

12. An infrared heater for an aerosol generation device, the aerosol generation device comprising a chamber configured to receive an aerosol forming substrate and a battery cell providing power to the infrared heater, wherein the infrared heater comprises:
a complex, prepared by a composite material containing a carbon material and a ceramic material; and the complex is constructed to heat the aerosol forming substrate received in the chamber at least in an infrared radiation manner; and
a conductive element, comprising a first electrode and a second electrode spaced apart on the complex; and the conductive element is configured to provide the power to the complex.

13. The aerosol generation device according to claim 3, wherein an organic carrier layer is arranged between the carbon material layer and the ceramic material layer.

14. The aerosol generation device according to claim 13, wherein the organic carrier layer comprises at least one of glass powder and acrylic latex.

15. The aerosol generation device according to claim 4, wherein an organic carrier layer is arranged between the carbon material layer and the ceramic material layer.

16. The aerosol generation device according to claim 15, wherein the organic carrier layer comprises at least one of glass powder and acrylic latex.
